(19) United States
(12) Patent Application Publication
(10) Pub. No.: US 2006/0152313 A1
(43) Pub. Date: Jul. 13, 2006

(54) Temperature sensing devices, systems and methods

(75) Inventor: Ronald Barry Zmood, Caulfield North, Victoria (AU)

Correspondence Address: OLIFF & BERRIDGE, PLC, P.O. BOX 19928, ALEXANDRIA, VA, 22320, US

(73) Assignee: MEMS-ID PTY LTD., Melbourne, Victoria (AU)

(21) Appl. No.: 10/549,191

(22) PCT Filed: Mar. 17, 2004
(86) PCT No.: PCT/AU04/00321

§ 371 Date: Nov. 16, 2005

(30) Foreign Application Priority Data
Mar. 17, 2003 (AU) 2003901253

(51) Int. Cl. H01H 37/00

(52) U.S. Cl. 335/208

(57) ABSTRACT

A temperature-monitoring device for attachment to an item, e.g. a frozen food or health product, includes a trigger member that is triggered by a set temperature condition to change state and so register exposure to the temperature condition. In one embodiment, the trigger member is biased to disengage a Thermalloy element once the Thermalloy's Curie temperature is exceeded and its magnetic force is weakened. The trigger member moves sufficiently so that it will not re-engage the Thermalloy, even if temperatures recede. Exposure to a high temperature can thus be determined from the trigger member's state, e.g. by detecting an impedance change in an associated circuit, e.g. in an adjacent coil through vibration of the trigger member under an applied signal, or in a circuit due to an open circuit at the trigger member and Thermalloy. The device may be manufactured using MEMS technology. To allow storage above the Curie temperature, a tether may initially hold the trigger member. The device may be activated, e.g. after freezing the item, by removing the tether, e.g. through laser ablation or a fusing current.

The present invention relates to temperature sensing devices, to temperature monitoring systems and methods using such devices, and to methods of fabricating such devices. It relates particularly, though not exclusively, to devices such as tags that indicate whether a predetermined temperature condition has occurred.

In many different situations, it would be desirable to know whether or not an item, such as a food product, health product or the like, has experienced an undesirable temperature condition. For example, if a food product has been left unchilled or has defrosted and become refrozen during its shelf life, it may become a health hazard, and any “Best Before” date may become invalid.

Similar concerns exist in many other situations. For example, temperature conditions may be critical in the storage of blood, plasma and vaccine products, and in the storage of many pharmaceutical and chemical products in general, as well as in relation to photographic and microelectronic equipment and the like.

Unfortunately, it is often difficult to determine whether or not an inappropriate temperature condition has been experienced merely from a visual inspection of a product.

The present invention, in one aspect, aims to provide a device that can monitor the temperature history of a product.

Viewed from one aspect, the present invention provides a temperature condition recording device for recording whether a predetermined temperature condition has been experienced, the device including a cantilever or bridge movable member that assumes a triggered state on exposure of the device to the temperature condition so as to register the occurrence of the temperature condition.

The present invention provides a device that may be fabricated simply and inexpensively. For example, the cantilever/bridge member may be fabricated using e.g. MEMS technology or precision stamping.

The device therefore is especially useful in the monitoring of high-volume, low-cost products, as each product may be individually tagged with a device at little additional cost.

Such constructions can also make the device essentially tamperproof, as any attempt to access the triggered member to reset it would be extremely difficult.

Further, the device is able to take on a compact and robust form, e.g. on a silicon substrate or the like, which facilitates the mounting of the device in a simple and unobtrusive manner. It may for example be attached directly to an item to be monitored or may be applied to associated packaging or the like.

The device may be configured for interrogation by an excitation signal, such as an electromagnetic field, so that it provides a characteristic response when triggered. Such embodiments allow for remote monitoring, and need not require the device to be internally powered, thereby facilitating small and inexpensive designs that do not need batteries or the like, and that can have long lifetimes. They can also provide the temperature information without the need for visual inspection, so that the tag need not be visible to the user.

In one preferred embodiment, the triggered state is a state in which the member is able to vibrate.

In another preferred embodiment, the triggered state is a state in which the member moves between two positions, e.g. to open or close a set of contacts. It may for example place an associated circuit in an open or shorted condition. It could also for example shunt a load, such as a resistance, capacitance or inductance, in to or out of an associated circuit.

The state of the cantilever/bridge member may be detected directly from a signal produced by movement of the member. In a preferred embodiment, however, the device includes circuitry associated with the member such that the circuitry generates a characteristic response to an interrogation signal when the member is in the triggered state. This circuitry preferably consists of or includes a coil. A property of the coil, preferably its impedance, may be determined, and changes in the coil property due to the triggered state may be recorded.

In one embodiment, the coil forms part of a circuit in which the movable member acts as a switch, the movable member preferably opening the circuit in the triggered state so as to set a high impedance for the circuit or shunting another component into or out of the circuit.

In another embodiment, when triggered, the movable member is able to vibrate in response to the excitation signal, and the coil may be positioned adjacent the movable member such that the impedance of the coil is altered by the vibration of the movable member.

When the triggered state is a vibratable state, the movable member may be vibrated directly by the excitation signal. Preferably, however, the device includes a coil that couples with the excitation signal to generate a magnetic field that vibrates the movable member. The same coil may also be monitored to detect a change in its impedance, so as to determine whether or not the movable member is vibrating in response to the excitation signal.

The movable member itself may consist of or include a magnetic material, e.g. a soft magnetic material, such as a nickel/iron alloy, e.g. Permalloy, so that it is able to be influenced by a magnetic or electromagnetic field and/or so that it is able to provide a response to an excitation signal.

The excitation/interrogation signal may comprise a swept RF signal. When coil circuitry is provided in the device, the impedance of the coil circuitry may provide a characteristic signal as the RF signal passes through the resonant frequency of the coil circuitry/movable member. Alternatively, an excitation signal could be applied at a frequency corresponding to the known resonant frequency of the movable member, and the response compared with an expected response for a particular movable member state.

Other interrogation methods are also possible. For example it is possible to design the movable members to vibrate in its triggered state in response to other forces. For example, the movable member may be driven to vibrate due the application of an ac current induced in circuitry in the device. It could for example vibrate in response to Lorentz type forces, electrostatic forces or piezoelectric forces. For example, for a Lorentz force, the movable member may be provided in a magnetic field and have a conductor extending across it, so that an ac current induced in the conductor at a suitable frequency will cause the member to resonate under the Lorentz force. For an electrostatic embodiment, the movable member may act as one electrode of a capacitor and e.g. a metallized portion of a supporting substrate may act as the other electrode, and for piezoelectric vibration, the movable element may have a layer of piezoelectric material, between a pair of electrodes, provided along its length. In both cases, again, an ac current induced across the electrodes will cause resonance of the member at a suitable ac frequency. Resonant vibration may be detected by a change in e.g. the driving impedance of the circuit supplying the ac current.

Such Lorentz, electrostatic and piezoelectric vibrating elements are further disclosed in the co-pending International Patent Application entitled “Memory Devices” filed on the same day as the present application to the same applicants, and claiming priority from Australian Provisional Application No. 2003901240.

Also, the device could include magnetostrictive or electrostrictive elements or the like, e.g. the movable member could be formed from such materials, so as to provide suitably detectable responses to an excitation signal after triggering.

Although the above emphasises remote interrogation of the device, which is a preferred and advantageous aspect of the present invention, it would also be possible to include on-board detection and display means, e.g. through the use of a microprocessor and an indicator, e.g. an LED or the like, in the device itself.

In one especially preferred form of the present invention, the temperature condition monitored is the passing of a threshold temperature, e.g. the increase above a threshold temperature. Other temperature conditions may also however be monitored.

The device preferably includes a temperature-sensitive element that acts on the movable member, so that changes in the state of the element due to the temperature conditions cause the movable member to assume the triggered state. In one preferred embodiment, the force exerted by the temperature-sensitive element may be reduced at a set temperature condition so as to allow the movable member to assume its triggered state.

In a particularly preferred embodiment, the temperature-sensitive element is a temperature-sensitive magnetic element. This is especially useful where the passing of a threshold temperature is to be monitored, as the temperature-sensitive element can be provided by a magnetic element having a Curie temperature that corresponds to the threshold temperature. Thus, at the Curie temperature, the material will become substantially less ferromagnetic in character, and the magnetic force exerted by the element on the movable member will reduce accordingly. The Curie temperature need not necessarily be an exact match to the threshold temperature, and may for example be offset slightly from it, e.g. it may be slightly below the threshold value. This may provide a safety margin, and may also compensate for differences in temperature between the temperature-sensitive element in the device and the item with which the device is associated.

The use of a temperature-dependent magnetic material, such as a copper/nickel alloy, e.g. Thermalloy, to latch the movable member facilitates a simple construction for the device. It also allows for flexibility in the design of the device, as it is possible to use magnetic materials having different Curie temperatures so as to provide devices that can operate at a number of threshold temperatures. This may be achieved for example merely by changing the percentage of copper in the copper/nickel alloy.

Preferably, the movable member is biased to the triggered state, and the temperature-sensitive element holds the movable member against the bias until the set temperature condition occurs.

The biasing force may be achieved in any suitable manner. In one preferred embodiment, the movable member is formed to be pretensioned. Alternatively, the device may include biasing elements, e.g. springs, such as leaf springs that may urge the movable member away from the magnetic material.

The bias is preferably such that once the movable member is tripped, it will not be recaptured by the temperature-sensitive element, e.g. because the movable member is suitably distant from the temperature-sensitive element that the attractive force is too weak to overcome the bias at that distance.

The device is preferably configured so that it needs to be activated before it begins to sense temperature conditions. This is generally preferable, as otherwise a device, such as a sensor that monitors the defrosting of an item, would need to be kept frozen prior to use.

In one preferred embodiment, the device includes an activation element, such as a tether, for preventing triggering of the movable member, which is independent of the temperature-condition to be monitored. The device may then be activated by disabling the activation element, e.g. by removing or weakening it, once the device is in place on an item to be monitored. Thus, once a temperature-monitoring device has been attached to an item and the item has been frozen, then the device's tether may be removed and monitoring may begin.

In a preferred embodiment, an activation element may hold the movable member against a bias in a non-triggered state. It may hold the movable member in position relative to a temperature-sensitive restraining element such that on activation of the device, the restraining element is able to take over from the activation element and hold the movable member out of the triggered state until the temperature condition to be registered is experienced.

In one preferred form, the activation element is a removable tether. The tether may be provided at one end of a cantilever movable member, or along a side of a bridge-type member, e.g. a tether could be provided on each side of the bridge at the middle thereof.

The tether may be a fusible tether, and the device may be activated by passing a suitably high current through the tether to cause it to melt/vaporise. The current may be provided in any suitable manner, e.g. via contacts that are connectable with an outside power source, or by inductive energization of a coil in the device. Such a coil could also act as a trigger indication coil for coupling with an interrogation signal.

In an alternative arrangement, the activation element could be a tether that is designed to be removed by ablation, e.g. through a suitable ablating beam, such as an electromagnetic beam, e.g. a laser beam, such as an Excimer laser.

Although so far discussed in relation to a single movable member, the present invention extends to devices having two or more movable members, e.g. an array of cantilevers or bridges. An array of movable members may be used for safety, e.g. to provide redundancy, and to ensure that one of them will activate, even if another is faulty. An array of movable members may also be used so as to provide a greater trigger signal than would a single movable member.

In an especially preferred embodiment, an array of movable member is provided in which the movable member trigger under different temperature conditions. This may be achieved by preventing the movable member from triggering using temperature sensitive restraining elements that trigger under different temperature conditions. Preferably, the device includes magnetic restraining elements that have different Curie temperatures.

By using movable members that trigger at different temperatures, the device can record the extent to which e.g. a threshold level has been exceeded. Thus, movable members that have not triggered would give an indication of e.g. the maximum temperature reached. Temperature resolution would depend on the temperature differences between the trigger temperatures. They could for example trigger at 1° C. intervals, although other intervals are of course possible.

The determination as to which of the movable members have been triggered may be achieved in any suitable manner. In one preferred embodiment, the movable members are designed to have different resonant frequencies so that on application of an excitation signal, the responses of the various member may be distinguished through their different resonant responses.

For example, by applying a swept RF frequency signal to the array, a change in impedance of an associated coil would be determined as a frequency corresponding to the resonant frequency of a triggered member was swept through. Preferably, the array of movable member is associated with a single coil, although each member or a sub-group of members could be associated with its own coil.

Other excitation signals are also possible, including for example the use of signals employing spread spectrum techniques and the like.

Besides determining response frequencies, the strength of a response signal may be determined. Thus, the reaching of a first threshold would trigger less movable member than the reaching of a higher threshold, and so would produce a weaker signal. In this case, the movable member could have the same resonant frequency.

Where the movable member of the array move between open and closed switching states, they could each be connected in parallel and switch in or out a load, e.g. a resistance, capacitance or inductance, so as to change a property, e.g. the impedance, of an associated circuit in a stepped manner as the cantilevers are triggered. The circuit could then be interrogated, e.g. by coupling with a circuit coil, to determine the circuit impedance or the like.

The device may be made in any suitable manner. In one embodiment, the device is made through precision stamping, e.g. using standard precision engineering and plastic moulding techniques. For example, this could use suitable foils in the manufacture of the movable members and restraining elements, such as Permalloy and Thermalloy foils, as well as e.g. plastic-bonded permanent magnets.

In a particularly preferred embodiment, the device is fabricated using MEMS (microelectromechanical systems) technology. Sometimes also known as MST (Micro System Technology) or micromachining.

MEMS technology includes technologies of Integrated Circuit fabrication, as well as technologies specifically developed for micromachining, and generally relates to the fabrication of components with dimensions in the micrometre to millimetre range.

A MEMS fabrication process typically includes the steps of lithography, e.g. photolithography, thin film deposition or growth, and etching, and typically results in a laminate device. Thus, a number of structural layers may be formed on a substrate, and required components may be formed by selective etching of the substrate and/or sacrificial materials deposited thereon.

The micromachined components may be combined with electronics that are fabricated using standard integrated circuit processes.

A movable member according to the present invention may be formed on any suitable substrate, e.g. a dielectric or semiconductor substrate, e.g. silicon, glass, ceramic, plastic, Kapton, cardboard or paper. Suitable changes would be made to the manufacturing process as necessary, e.g. an Excimer laser could be used to machine trenches in Kapton instead of the etching used to provide trenches in a silicon substrate.

The device may be made through fabrication of a movable member body part on a substrate and etching of the substrate from regions below the body part.

In order to provide a biasing force to a triggered state, the movable member may be fabricated from body parts having different thermal coefficients of expansion.

In one preferred embodiment, the two body parts are a magnetic material, such as Permalloy, and a portion of the substrate on which the device is formed.

The movable member and tether or tethers may be fabricated integrally with one another, and the material for the two may be deposited onto the substrate at an elevated temperature, so that the natural position of the movable member (at the appropriate temperatures in which the device is to be used) is above the tethered position in which it is deposited. Thus, once the tether is removed, the movable member will wish to move to the natural position, but will be restrained by e.g. a magnetic force from a temperature-sensitive restraining element. Once triggered, the movable member will move into the natural position away from the temperature-sensitive element so as to avoid recapture.

Another method of providing the biasing force is to introduce residual stress into the movable member, e.g. into electroplated films on the movable member by adjusting the plating process. The stress could be introduced as e.g. a compressive or tensile stress, and will be dependent on the plating conditions, as well as on any additives placed in the plating-bath electrolyte.

The movable member may take on any suitable size and be made from any suitable material. This may be determined for example by a resonant frequency at which it is required to vibrate, and on e.g. the type of interrogation signal it is to respond to and on the type of response that is to be detected. It may be fabricated from a soft magnetic material, such as a nickel/iron alloy, e.g. a Permalloy material.

Although not required to allow vibration, if desired, the movable member, may couple with a permanent magnet on the device to provide a magnetic bias, so that it may interact with an applied field. Alternatively, biasing could be provided by an external magnetic field, or the movable member itself could be made of a permanent magnetic material.

The tether may also take any suitable form to allow it to be removed without damaging the other components of the device. For example it may be made from a material more susceptible to melting or ablation than the cantilever, and/or more readily made to absorb a laser beam's energy or the like. Preferably, the tether is made of narrower dimensions than the movable member, so that it will melt or ablate at a lower fusing current or laser power. In this case, the tether may be made integrally with the movable member from the same material.

The temperature-sensitive magnetic element may be a nickel/copper alloy, such as a Thermalloy. This alloy is particularly advantageous, as it has a Curie temperature that may be varied by varying the amount of copper in the alloy, and so the device may be tailored for a particular use merely by varying the alloy's composition.

In one preferred construction, the device includes a permanent magnet that provides a magnetic restraining force through a temperature-sensitive magnetic element to hold the movable member in place. The movable member may also be coupled to the permanent magnet, from the opposing pole. The substrate on which the movable member is fabricated may be mounted on a further substrate, e.g. a PCB or a flexible substrate, that has associated electronics fabricated on it. Alternatively, the whole device may be fabricated on the same substrate.

Typically, many sensors will be made in a batch fabrication process, and the sensors will then be cut out into separate sensing devices.

The device is preferably fabricated so that the movable members vibrate in a vacuum. This facilitates a high quality factor Q, which in turn facilitates a large change in impedance at resonance. It also facilitates the use of resonant frequencies in the range of about 1 MHZ to 2.5+ GHZ. The high frequencies facilitate the use of resonant members of small physical size, so as to provide a large number of movable member in the array embodiments.

The device may be used in any suitable situation in which temperature history is of importance. It may be used for example for food products, which may be chilled or frozen or have some other requirement as to a maximum temperature. It may also be used in relation to blood, plasma and vaccines, pharmaceutical products, and in other fields of the health care system. Further uses include temperature sensitive industrial products (e.g. resins, paints and the like). Still other applications would be for microelectronics, photographic materials and chemicals in general.

Also, the device may be used to indicate that a particular temperature has been reached in situations where this is desirable, e.g. when cooking, or pasteurising a product or the like. Thus, the device could be placed on an object that is to be heated before it is placed in an oven, such as a cooking or sterilizing oven, and the oven or other interrogator could indicate that the heating may stop when a signal is received from the device or that during heating the correct temperature was indeed reached.

The device may be provided in any suitable form, and could be a tag or label that can be affixed to an item or to its packaging. The tag or label could include further information, such as a bar code or the like, so that both the product history and its temperature conditions could be captured simultaneously, e.g. by providing a combined interrogator and bar code reader.

In one preferred embodiment, the device is provided in association with an RFID device that provides identification of the item. This has the advantage that both can be interrogated remotely. The RFID device may take any suitable form, but preferably takes the form of a plurality of resonant members, e.g. cantilevers, of differing resonant frequency, that can represent data by being in a vibratable or non-vibratable state. The RFID data can then be read by the application of a suitable interrogation signal, e.g. a swept RF field, and by detecting at which of the resonant frequencies a response is present.

One such RFID device is taught in the co-pending International Patent Application entitled “Memory Devices” filed on the same day as the present application” in the name of the same applicants and claiming priority from Australian Provisional Patent Application 2003901240, the contents of which are incorporated herein by reference. This device uses a plurality of resonant members, such as cantilevers, that are tethered, data being written to the device by removing the tethers so as to allow the resonant members to vibrate freely.

In these cases, the RFID and temperature sensor can be fabricated together on the same substrates, so as to provide a particularly advantageous arrangement, and can be read using the same interrogating apparatus. The temperature-sensing movable member should have a resonant frequency different from those employed by the RFID part of the device.

The present invention relates not only to the temperature monitoring devices themselves, but also to systems utilising such devices, and, viewed from a further aspect, the present invention provides a temperature condition monitoring system for determining whether an item has experienced a set temperature condition, the system including a temperature monitoring device as in any of the herein discussed possibilities, and an interrogator including a signal generator for applying an interrogation signal to the device and a receiver for receiving a response to the interrogation signal and for analysing the signal in order to determine if the device has been triggered.

Preferably, the interrogator applies a swept RF signal to the device, and the receiver checks for a change in the response of the device, at a resonant frequency associated with the movable member.

In the various designs of temperature sensor, the movable member may preferably be configured as cantilever member, as this can easily move between the required trigger states. The present invention may also be achieved using a bridge type structure, and could for example use a strip of material that is anchored at each end, but free to vibrate along its length.

Viewed from a further aspect, the present invention provides a temperature condition monitoring system for determining whether an item has experienced a set temperature condition, the system including a temperature sensing device having a movable member that when exposed to the temperature condition moves to a triggered position in which it causes the device to respond to an excitation signal with a characteristic response signal, and an interrogator including a signal generator for applying an interrogation signal to the device and a receiver for receiving a response to the interrogation signal and for analysing the signal in order to determine if the movable member has been triggered.

The present invention also extends to an interrogator for determining whether a movable member of a temperature condition recording device has been triggered, the interrogator including a signal generator for applying an excitation signal to the device and a receiver for detecting a response from the device and for determining from the response whether the movable member has been triggered, the interrogator providing a signal when the movable member is found to be have been triggered to indicate that the device has experienced the temperature condition.

The invention further extends to methods of monitoring the temperature conditions that an item has been subjected to using a device in accordance with any of the herein discussed possibilities.

Thus, viewed from a further aspect, the present invention provides a method of monitoring the temperature conditions to which an item is exposed, the method including the steps of associating a device according to any of the herein discussed possibilities with the item, and of reading the device to determine whether the device has triggered.

The invention also extends to a method of determining whether an item has been exposed to a particular temperature condition, including the step of applying a temperature sensing device to the item, the temperature sensing device including a movable member that when exposed to the temperature condition moves to a triggered position in which it causes the device to respond to an excitation signal with a characteristic response signal, and the step of applying an excitation signal to the device to determine if the characteristic response is received.

Still further, the present invention provides a method of determining whether an item has experienced a set temperature condition, the method including the steps of:

applying a temperature sensing device to the item, the device including a movable member that is biased towards a triggered position, but that is held by an activation element in a non-triggered state in a position in which on activation of the device a temperature-sensitive element is able to prevent the movable member from triggering when said temperature condition has not occurred;

placing the item in a condition other than the set temperature condition;

disabling the activation element; and

at a later time detecting whether said movable member has triggered.

The invention also relates to methods of fabricating a temperature monitoring device, and, viewed from a further aspect, the present invention provides a method of fabricating a temperature monitoring device including the steps of depositing a permanent magnet onto a dielectric substrate, depositing and etching a cantilever or bridge structure onto the dielectric substrate such that the structure is coupled to the permanent magnet and is biased to a first triggered state, and depositing a temperature-sensitive magnetic structure onto the substrate so that it is coupled to the permanent magnet, the arrangement being such that when the temperature-sensitive magnetic structure is below its Curie temperature it is able to restrain the cantilever or bridge against the bias in an untriggered state, and when said Curie temperature is exceeded; the cantilever or bridge is able to move to the triggered state under the bias.

Preferably, the cantilever or bridge structure is fabricated with an integral tether that holds the structure in an untriggered state prior to activation of the device by removal of the tether.

Viewed from a further aspect, the present invention provides a temperature sensing device for determining whether an item has been exposed to temperatures that exceed a predetermined threshold temperature, the tag including a movable member held against a bias in an untriggered position by a temperature sensitive magnetic element having a Curie Temperature corresponding to the threshold temperature, such that when said threshold temperature is exceeded, the movable member is free to move to a triggered position.

Viewed from another aspect, the present invention provides a method of monitoring the temperature an item is exposed to, including the steps of tagging the item with a temperature sensing device that includes a trigger element that is restrained by a magnetic element when the temperature is below a set value and is restrained by an activation element independent of the temperature, and including the steps of cooling the tagged item and releasing the trigger element from the activation element so that the trigger element is restrained only by the magnetic element, and detecting the state of the trigger element at a later time.

Viewed from a still further aspect, the present invention provides a method of determining whether a temperature of an item has increased passed a threshold temperature, the method including the steps of:

applying a temperature sensing device to the item, the device including a movable member that is biased towards a triggered position but that is held by a restraining member in a position in which a magnetic element is able to restrain the movable member, the magnetic element including a temperature-dependent portion having a Curie Temperature corresponding to the set threshold temperature such that below the Curie Temperature the magnetic element is able to restrain the movable member, and such that above the Curie Temperature the magnetic element is unable to restrain the movable member from movement to said triggered position;

cooling the item to below the threshold temperature so that the magnetic element is able to exert a force that is able to restrain the movable member against said bias;

removing the retaining element so that said movable member is held against said bias only by said magnetic element; and

at a later time applying a signal to said device to determine whether said movable member has been triggered.

Viewed from another aspect, the present invention provides a temperature-sensing device including a trigger member fabricated through MEMS technology, the trigger member changing state on experiencing a predetermined temperature condition.

Viewed from a further aspect, the present invention provides a temperature-sensing device including a cantilever or bridge member, wherein on exposure to a particular temperature condition, the state of the cantilever or bridge member is changed.

Viewed from a still further aspect, the present invention provides a temperature-sensing device having a trigger element that is freed to vibrate once the device experiences a predetermined temperature condition.

Viewed from another aspect, the present invention provides a temperature-sensing device having a trigger element that moves to a triggered position on experiencing a set temperature condition, movement of the trigger element to the triggered position altering the response of an associated circuit, e.g. including or consisting of a coil, to an interrogation signal.

Viewed from a further aspect, the present invention provides a temperature sensor including a vibratable element that is held against vibration when the device has not experienced a predetermined temperature condition, but that is released to vibrate once the temperature condition has been experienced. Preferably, the sensor includes a circuit, e.g. including or consisting of a coil, whose response to an interrogation signal alters depending on whether said vibratable element is able to vibrate. Preferably, the sensor includes an activation element that prevents the vibratable element from vibrating irrespective of the temperature conditions, and that is disabled in order to activate the sensor.

Viewed from another aspect, the present invention provides a method of determining whether an item has been exposed to a particular temperature condition, including the step of applying a temperature sensing device to the item, the temperature sensing device including a vibratable member that is restrained against vibration unless it has been exposed to the temperature condition, and the step of providing an excitation signal to said device and analysing the response to determine whether the vibratable element is vibrating.

The present invention may also be seen to reside in the use of the temperature-sensitive magnetic element.

Thus, viewed from a further aspect, the present invention provides a temperature sensor including a trigger element that is held in a first untriggered state by a temperature-sensitive magnetic element when the device has not experienced a predetermined temperature condition, but that is released once the temperature condition has been experienced.

Viewed from a further aspect, the present invention provides a temperature registering tag for determining when an item associated with the tag has been exposed to temperatures that exceed a threshold value, the tag including a trigger element that is held in a first state against a bias by a temperature-sensitive magnetic element, the magnetic element having a Curie Temperature corresponding to the threshold temperature, the trigger element being placed in a triggered state when the temperature exceeds the threshold temperature due to a reduction in the magnetic force exerted by the temperature-sensitive element.

Viewed from another aspect, the present invention provides a tag having a temperature-sensitive restraining means that prevents a trigger element from being triggered unless the tag has experienced a set temperature condition, and a temperature-independent restraining means that also prevents triggering, wherein the temperature-independent restraining means can be disabled so as to activate the tag.

Viewed from a further aspect, the present invention provides a temperature monitoring device, the device including an array of cantilevers or bridges, each being able to assume a triggered state under a different temperature condition.

The present invention also provides a temperature monitoring device including a first member that can assume a triggered state on experiencing a set temperature condition and a plurality of further members of different resonant frequencies from one another and from the first member that vibrate in response to an interrogation signal in order to provide identification data.

The present invention may also extend to devices which do not have a memory function, but instead may act as indicators of a current temperature. Thus, e.g. without a bias force or without a bias force as strong as that used in the memory embodiments, the movable member/trigger element may move back to a home position, e.g. in contact with a temperature-sensitive magnetic element, such as a Thermalloy element, whenever e.g. the temperature falls back below the Curie temperature. If such a device were e.g. placed on an object, then the temperature condition of the object at the time of interrogation could be obtained. Thus, the device could indicate whether or not it was above or below a temperature threshold, or if an array of movable members were used, it could indicate the actual temperature (within the resolution of the temperature trigger points).

Thus, the present invention extends to a temperature-sensing device having a movable member, preferably an array of movable members, restrained in a first state by a temperature-sensitive element, such as a temperature-sensitive magnetic element, the temperature-sensitive element releasing the movable member or members when the device experiences a certain temperature condition. The movable member may be able to resonant when released and/or may move to a second position under a bias force, e.g. to open or close a contact, as in the above-mentioned embodiments, and is preferably formed using MEMS technology. These devices would not need activation tethers.

The present invention, in this form, may thus provide a device that can act as a temperature indicator, e.g. in the array embodiment it may act as a thermometer. It may provide a remotely interrogated thermometer having a resolution dependent on the temperature differences between the releasing of the cantilevers. It would be possible to provide on-board detection of the array, e.g. by providing the device with a microprocessor. The device may also include a temperature indicator or display, e.g. an LED or LCD display. This could then provide a stand-alone temperature-sensing device, although the device could also be provided as a component of another device.

It should be noted that any of the features of any of the above aspects may be applied to any of the other aspects

Embodiments of the present invention will now be described, by way of example only, with reference to the accompanying drawings. It is to be understood that the particularity of the drawings does not supersede the generality of the preceding description of the invention.

In the drawings:

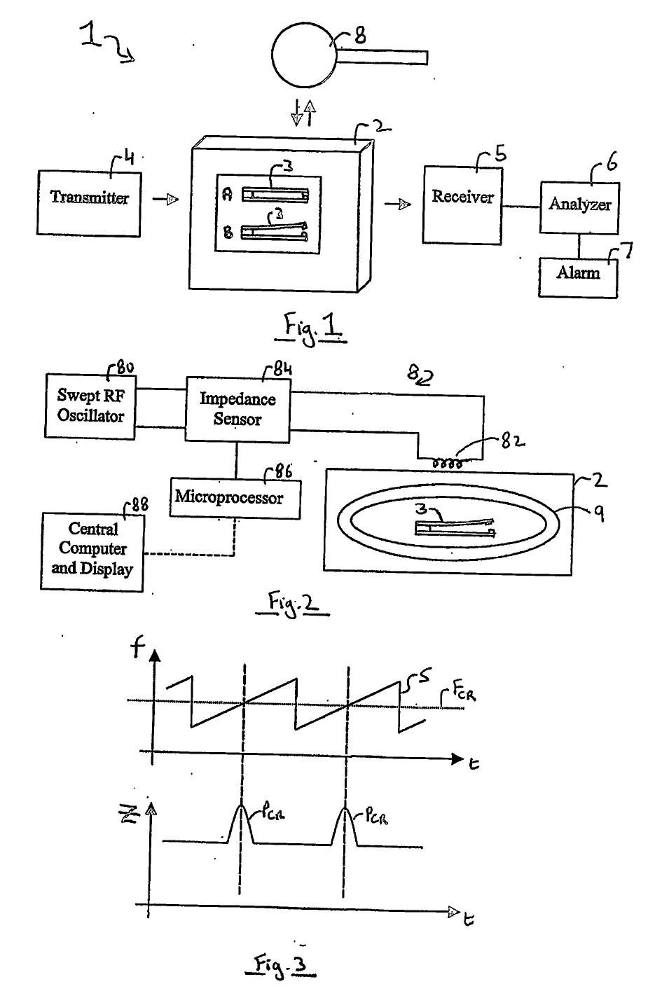

FIG. 1 is a schematic diagram of a tagging system for the monitoring of the temperature history of an item;

FIG. 2 is a schematic diagram of a tag and hand-held interrogator arrangement;

FIG. 3 is a graph representing an excitation signal applied by the interrogator of FIG. 2 and the resulting impedance signal from a tripped tag;

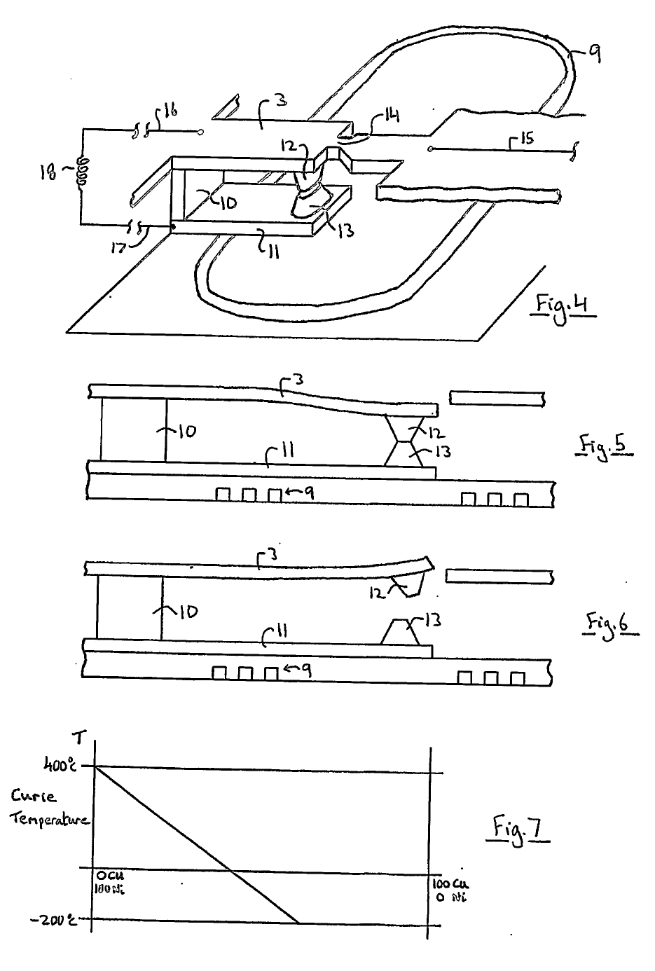

FIG. 4 is a schematic perspective view of one embodiment of a cantilever structure in an unactivated state;

FIG. 5 is a schematic cross-sectional view of the cantilever structure of FIG. 4 in an activated state;

FIG. 6 is a similar view to FIG. 5, but with the cantilever structure tripped;

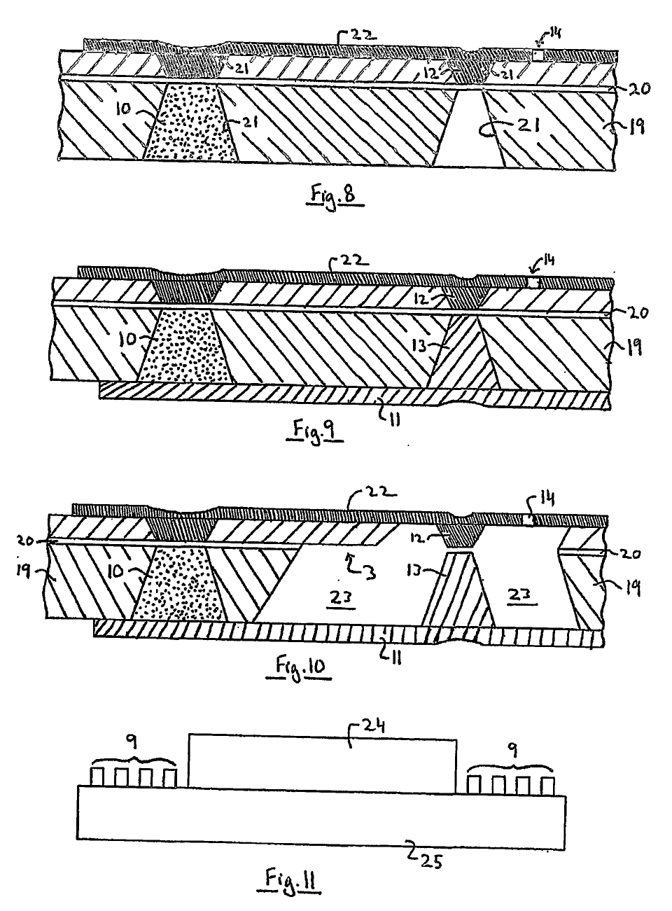

FIG. 7 is a graph showing the Curie temperature of a Thermalloy material as a function of Nickel and Copper content;

FIGS. 8 to 11 show schematically various stages in the fabrication of a tag such as shown in FIG. 5;

FIG. 12 is a graph of cantilever biasing force and magnetic force at different cantilever displacements and temperatures;

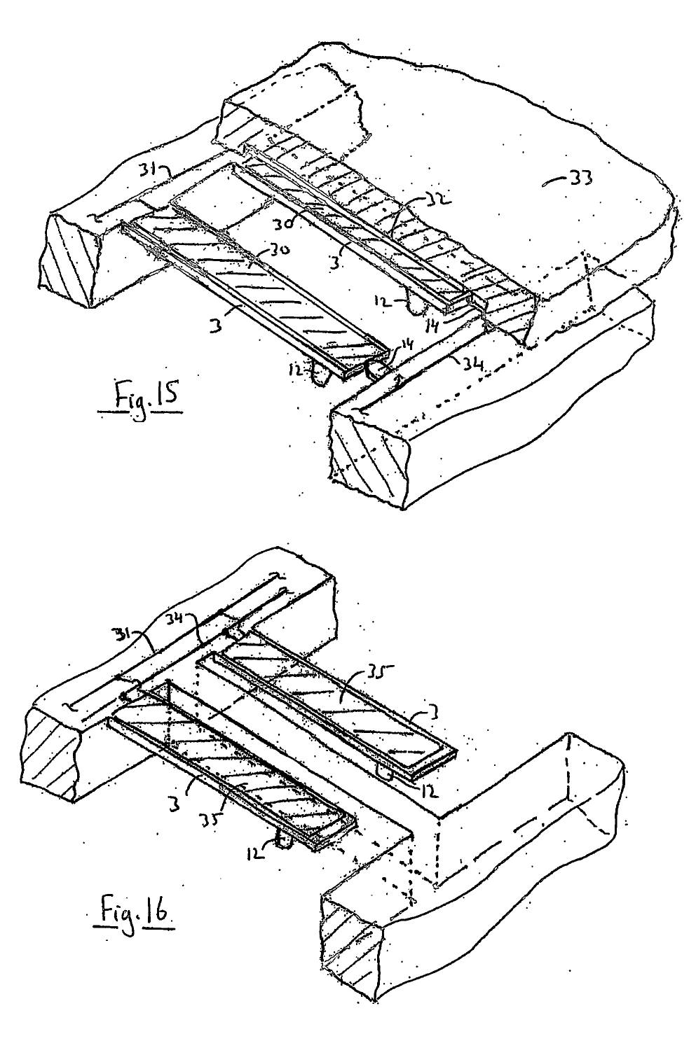

FIG. 13 is a schematic diagram of a tag having an array of cantilevers;

FIG. 14 is a graph representing an excitation signal applied to a tag such as shown in FIG. 13 and a resulting impedance signal from the tag;

FIG. 15 is a further possible cantilever structure; and

FIG. 16 is another possible cantilever structure.

Referring to FIG. 1, a system 1 for detecting whether an item has been exposed to a particular temperature condition includes a monitoring tag 2 that may be attached to the item. The tag 2 is designed to trip when the item experiences the temperature condition of interest.

The tag 2 includes a cantilever 3 that is either in a state “A” or “B”, depending on whether the item to which it is attached has experienced the temperature condition. Once tripped, the cantilever 3 will not return to its initial position, and so will permanently register the exposure of the item to the monitored temperature condition. It will have a memory of the event.

The state of the cantilever 3 may be determined in any suitable manner. In the system shown, the cantilever state is determined by applying an excitation signal to the tag 2 and by detecting a response to or a disturbance in the excitation signal, caused by the cantilever 3. This may be achieved for example by using a separate transmitter 4 and receiver 5 (together with a signal analyser 6 and alarm unit 7), or for example by using a single transceiver/interrogator device 8 that e.g. may take the form of a hand-held wand or the like.

The temperature condition may be that the temperature of the tagged item has exceeded a threshold value. The result of passing this threshold value may be that the cantilever 3 is released by a suitable temperature-sensitive restraining means from a restrained state “A”, in which it is unable to vibrate in response to an applied field, to a free state “B”, in which it is able to vibrate in response to an applied signal. The analyser 6 may therefore check for a response/disturbance in the signal detected by the receiver 5, which corresponds with the vibration of the cantilever 3, e.g. at a characteristic resonant frequency. If the characteristic disturbance is found, and so the cantilever 3 is determined to be in its free state, then the alarm unit 7 may actuate a suitable alarm, such as an audible alarm and/or a warning light, in order to indicate that the item has exceeded the threshold temperature level at some time and so for example may not be fit for use.

A magnetic force may be used to hold the cantilever 3 in the restrained state, the force weakening to release the cantilever 3 when the temperature exceeds the threshold value. This may be achieved for example through the use of a material that has a Curie temperature corresponding to the threshold temperature. At the Curie temperature, the material would lose its ferromagnetic properties and the restraining force would therefore reduce, thereby allowing the cantilever 3 to escape, e.g. under a biasing force. Once in the freed position, the balance of the forces can be such that the cantilever 3 will not be restrained again, even if the temperature were to return below the threshold value and the magnetic field were to return to its original strength.

Activation means may be provided to hold the cantilever in a restrained position prior to use, when for example the temperature may be too high for it to be held by the temperature-sensitive means. These activation means may be disabled when the tag 2 is to be activated for use and is to begin monitoring. The activation means could be in the form of a tether that may be fused or ablated.

The tag 2 may be made small, robust and inexpensive through the use of MEMS (microelectromechanical) technology. Thus, a user can have confidence in the tag 2, and can tag items individually even if they are of high volume and low-cost.

The tagging system may be used in many different situations. In a particularly useful situation, the tag 2 is applied to frozen foods, so that the tag 2 will indicate any foodstuffs that have been defrosted and refrozen.

This would have the advantage of increasing consumer confidence in the fitness of a product, and of allowing retailers and the like to identify unfit goods that should not be sold, as well as allowing retailers and/or suppliers to monitor the goods at various stages in the supply chain so as to identify the stages at which handling problems might be occurring.

Similar advantages would apply to other temperature monitoring regimes, such as for chilled foods, and may extend to many different areas where the exposure of an item to a certain temperature condition would be undesirable. Such items could include for example vaccines, blood and plasma products, pharmaceuticals, chemicals, industrial products, such as resins and paints, etc., photographic materials, microelectronics and the like.

The tag 2 could also be used in situations in which it is desirable to experience a particular temperature condition. This would include for example situations in which an item, such as a foodstuff or a healthcare product, needs to be raised to a set temperature in order to ensure proper cooking or the destructions of pathogens. In this case, the tag 2 could confirm that the correct temperature was reached

The tag 2 may be attached directly to the item or to packaging associated with the item, e.g. to the packaging of an individual item or to a container or other support holding a number of the items.

FIG. 2 shows a possible tag 2 and transceiver 8 arrangement, in which the tag 2 includes an excitation/indicator coil 9 that is provided adjacent the cantilever 3. The cantilever 3 has suitable magnetic characteristics so that, when in its freed state, it may vibrate in a suitably applied field, and thereby alter the impedance of the cantilever/coil combination. The cantilever 3 is also fabricated so as to have a predetermined resonant frequency, e.g. through appropriate setting of its physical dimensions.

The transceiver 8 includes a swept RF oscillator 80, which generates an excitation signal that is transmitted to the tag 2 via an antenna 82. The coil 9 produces a magnetic field, through its interaction with the excitation signal, that vibrates the cantilever 3. The cantilever 3 in turn alters the coil impedance. The impedance of the tag coil 9 is detected by an impedance sensor 84, and the result is analysed by a microprocessor 86 to determine the state of the cantilever 3. The results may be displayed on a suitable display of the transceiver 8, e.g. an LCD display, together with a warning sound, and/or may be sent to a central computer 88, e.g. via a wire lead or wireless transmission.

Possible excitation and response signals for this arrangement are shown in FIG. 3. As can be seen, the swept RF oscillator 80 applies an electromagnetic field signal S that sweeps through a range of sine wave frequencies in a saw-tooth manner. The swept range of frequencies includes a frequency corresponding to the resonant frequency F_{CR} of the cantilever 3. Depending on how the tag is fabricated, this corresponding frequency may be e.g. one half of the resonant frequency of the cantilever, e.g. for the structure shown below in relation to FIG. 4, or, where a biasing field is provided, it may be equal to the resonant frequency.

If the tagged item has been exposed to temperatures exceeding the threshold temperature, the cantilever 3 will be tripped, and will vibrate freely when the excitation signal S passes through the frequency corresponding to the cantilever's resonant frequency F_{CR}. This will cause a change in the impedance of the coil 9, which will be detected as a pulse P_{CR} in the impedance signal.

Thus, detection of the pulses P_{CR} indicates that the temperature threshold has been passed, and that the tagged item may therefore need to be rejected from use, used earlier than otherwise indicated or used before another such item, or the like.

Referring to FIGS. 4 to 7, one particular form of cantilever structure will now be described, which e.g. may be fabricated using MEMS technology, e.g. on a silicon substrate or the like.

In this structure, the cantilever 3 and a temperature-sensitive magnetic element 11 are magnetically coupled to a permanent magnetic element 10 from which they extend. Both have a pole face/contact 12,13 at their far ends. The cantilever 3 and pole faces/contacts 12,13 are fabricated from soft magnetic material, whilst the temperature-sensitive magnetic element 11 is made to have a Curie Temperature T_{C} that corresponds with the threshold temperature that the tag is designed to sense. The cantilever 3 may be made form a nickel/iron alloy, e.g. a Permalloy, whilst the temperature sensitive element 11 may be made for a nickel/copper alloy, e.g. a Thermalloy.

In an activated (monitoring) position, shown in FIG. 5, the two pole faces/contacts 12,13 engage one another, so that whilst the tag is below the Curie temperature of the temperature-sensitive element 11, the cantilever 3 is held in a “restrained/closed” position by a magnetic force.

The cantilever 3 is biased so as to take up a “free/open” position as shown in FIG. 6, once the magnetic force is weakened by an increase in tag temperature above the Curie temperature of the temperature-sensitive element 11. The biasing may be provided for example by fabricating the cantilever 3 so that it is suitably pre-tensioned (or by providing a spring, e.g. leaf spring, or other biasing elements).

Prior to activation of the tag, i.e. before monitoring needs to begin, the cantilever 3 is held in position against its bias by a temperature independent restraining element (a removable tether 14 in FIG. 4), so that the poles 12/13 lie adjacent one another. This allows the tag 2 to be handled at temperatures above the Curie temperature of the temperature-sensitive element 11 without the tag triggering. This aids in storage and deployment of the tag 2, and can also simplify the fabrication process.

In order to activate the tag and begin monitoring, e.g. after its attachment to a product and after the freezing of that product, the tether 14 is broken.

This may be achieved by ablation e.g. through the use of an electromagnetic beam, such as a laser beam, e.g. an Excimer laser. A narrow beam may be targeted at the tether itself or a larger beam may extend over the whole tag and the tether may be designed to be relatively more susceptible to ablation than the rest of the structure, for example through its dimensions, e.g. its width and/or thickness, and/or through the choice of material(s) from which it is fabricated, e.g. a material that is easily ablated and/or good at absorbing the particular electromagnetic wavelength applied. A photomask may be used to mask the device apart from the tether, and to allow e.g. UV radiation from an Excimer laser to pass through a window in the mask to ablate the tether.

As a further possibility, the tether 14 may be designed to be fused when a sufficiently high current passes through it. Thus, if the current is suitably large the tether 14 will vaporise. The current may be applied through conductive tracks 15 and 16. These may lead to terminals that enable connection with an external power supply. Alternatively, the tracks 15 and 16 could be part of an inductive circuit that may be energised by suitable coupling with an external energising coil.

Once the tether 14 is broken, the free end of the cantilever 3 is attracted to the pole face/contact 13 of the temperature-sensitive element 11 under the magnetic force applied by the magnetic circuit of the permanent magnet 10 and temperature-sensitive element 11. The cantilever 3 thus takes the position shown in FIG. 5.

Should the tag's temperature at any time rise above the Curie temperature of the temperature-sensitive element 11, then the magnetic force holding the cantilever 3 is reduced, and the cantilever 3 moves into the position shown in FIG. 6 under its bias. In this position, the pole faces/contacts 12,13 are disengaged, and the cantilever 3 is free to vibrate. Further, the force balances are such that even if the tag temperature returns below the Curie temperature of the temperature-sensitive element 11 and the magnetic strength of the circuit increases, the cantilever 3 will not be recaptured.

The tag 2 therefore provides a temperature trip switch that triggers at the threshold temperature and remains in this position to flag the temperature rise.

The change in state of the cantilever 3 may be sensed in any suitable manner. In one embodiment, the cantilever 3 is made to vibrate through the application of a suitable excitation signal. The signal couples with the coil 9, such that the coil 9 generates a magnetic field to vibrate the cantilever 3. The vibration of the cantilever 3 in turn alters the impedance of the coil 9, and the impedance change is detected by a remote coil, e.g. as in the FIG. 3 example.

The coil 9 extends beyond the area of the cantilever 3, and can be much larger than this area, so as to enhance the coupling with the external interrogator.

In another embodiment, the open position of the contacts 12,13 may be detected. This may be achieved by placing the contacts 12,13 in a suitable circuit e.g. through conductive tracks 16 and 17. In this case, the structure is fabricated so that the cantilever 3 and temperature-sensitive element 11 are electrically isolated from one another apart from when the contacts 12,13 connect. The characteristics of the circuit can then be monitored to determine if the contacts are open or not. For example, the circuit may include a coil 18, e.g. a planar coil, which will inductively couple with a remote interrogator coil. If the contacts 12,13 are closed, then the circuit will be of low impedance, and the circuit behaves like a shorted secondary of a transformer. If the contacts 12,13 are open, then the secondary will be open-circuited and will be of high impedance. This change of impedance can then be detected, e.g. by the impedance sensor of FIG. 2. The contacts 12,13 could also shunt a load, such as a resistance, capacitance or inductance, in to or out of a circuit, e.g. to vary the impedance of the coil circuit.

It will be understood that in the light of the present teachings, a skilled person may fabricate various suitable tag structures using various possible materials and methods, as would be well-known in the art.

The substrate on which the cantilever and coil structure are mounted could be e.g. a dielectric or semiconductor material. It could be e.g. silicon, glass, quartz, ceramic, plastics, Kapton, paper, cardboard or any other suitable dielectric material.

The permanent magnet may be micro-fabricated, e.g. an epoxy/permanent magnetic material composite, an electro-deposited permanent magnet material, a machined bulk permanent magnet material, or a sputtered permanent magnet material.

The cantilever 3 and poles/contacts 12,13 may be made of soft magnetic materials, e.g. a nickel/iron alloy, such as Permalloy, which may be electro-deposited.

The temperature-sensitive element 11 may be electro-deposited, and may be a Nickel/Copper alloy, e.g. a Thermalloy. The alloy's Curie temperature may be adjusted to correspond to a desired threshold temperature for the tag by adjusting the Nickel/Copper ratio. For this alloy, the Curie temperature is nearly linearly dependent upon the percentage of Copper, as shown in FIG. 7. The ratio may be set during manufacture of the tag, as the temperature-sensitive element 11 is laid down.

A suitable structure could also be fabricated using non-MEMS techniques, e.g. through precision stamping of Permalloy foil and Thermalloy foil. “Plastic” bonded permanent magnets could also be used.

One method of tag fabrication is described with reference to FIGS. 8 to 11 using a silicon-on-insulator (SOI) wafer 19 that includes an insulating silicon dioxide layer 20.

Trenches 21 are etched into the SOI wafer 19 from both sides (e.g. using KOH etch). A tethered cantilever structure 22 of Permalloy is then electro-deposited onto the top of the wafer 19. The shapes of the cantilever 3 and tether 14 are defined laterally by suitable patterning with a photoresist mask, and the Permalloy is electroplated into moulds formed by the photomasking process in the top of the wafer 19 including into two of the trenches 21. The material in one of these trenches 21 forms the cantilever pole/contact 12, and the material in the other allows for coupling with the permanent magnet 10.

The permanent magnet material, e.g. Epoxy SmCo5 composite applied by a silk screen method, or PtCo alloy applied by electro-deposition, is deposited into another of the trenches 21 to form the permanent magnet 10. As shown in FIG. 9, the Thermalloy structure 11 including pole/contact 13 is then electro-deposited on the under surface of the wafer 19.

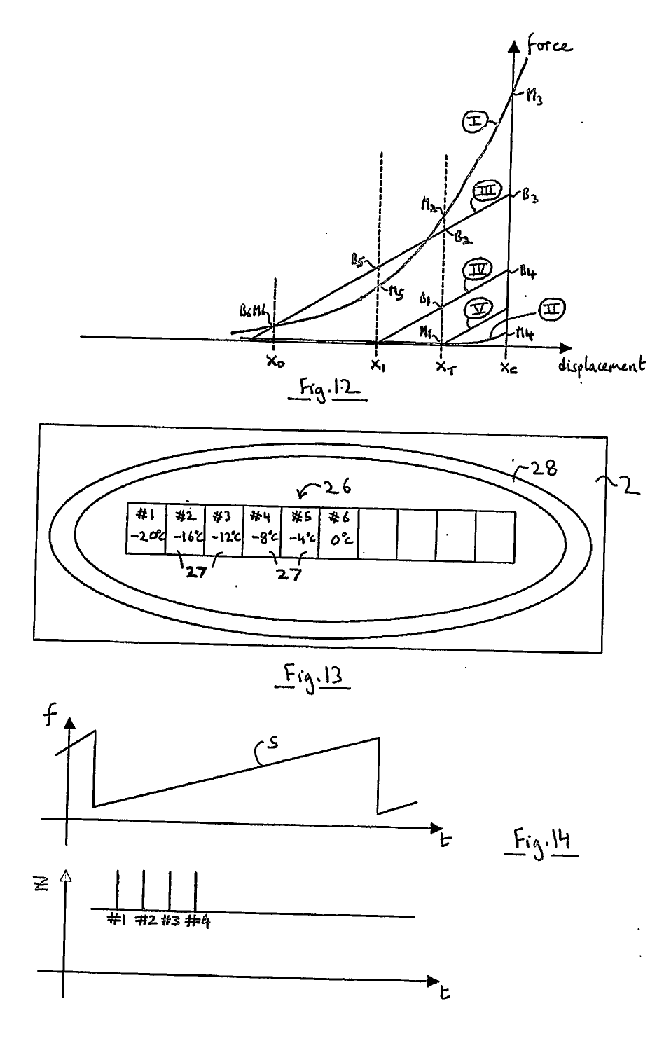

Once these structures are in place, as shown in FIG. 10, further trenches 23 are wet-etched to remove material from below the cantilever and tether structure 22, so as to release the cantilever 3 and tether 14 from the substrate. Further, the insulator layer 20 is etched from between the contacts 12,13.

In practice a number of these sensor structures are fabricated on the same substrate, and are then diced into separate sensor elements. As shown in FIG. 11, each of these sensors elements 24 may then be mounted on a PCB or other substrate 25, e.g. a flexible substrate, which has the inductive coil 9 already fabricated thereon.

The above steps will generally include various sub-steps. For example, each step will require one or more photolithography steps, and each plating step will require a deposition of a plating base. These techniques will be well understood by a person skilled in the art.

The device is preferably fabricated so that the cantilever vibrates in a vacuum. This facilitates a high quality factor Q, which in turn facilitates a large change in impedance at resonance. It also facilitates the use of resonant frequencies in the range of about 1 MHZ to 2.5+ GHZ. The high frequencies facilitate the use of cantilevers of small physical size, so as to provide a large number of cantilevers in an array embodiment as discussed below in relation to FIG. 13.

The Permalloy plating of the cantilever 3 may be carried out at an elevated temperature so as to provide a biasing force on the cantilever 3 away from the pole/contact 13. This occurs due to differential expansion of the silicon and Permalloy materials, as they have differing thermal coefficients of expansion. Thus, the cantilever 3 is pretensioned to move away from the pole/contact 13 once the tether 14 is removed.

Alternatively, another way of providing the biasing force is to introduce residual stress into the cantilever 3, e.g. into electroplated films on the cantilever 3 by adjusting the plating process. The stress could be introduced as e.g. a compressive or tensile stress, and will be dependent on the plating conditions, as well as on any additives placed in the plating-bath electrolyte. Such procedures would be well understood by a person skilled in the field.

FIG. 12 shows the force versus displacement curves I-V of the cantilever spring force and the magnetic force at different temperatures, so as explain the movement of the cantilever 3.

Curve I is the magnetic force at −20° C. Curve II is the magnetic force at +20° C. Curve III is the bias force at −20° C. Curve IV is the bias force at +20° C. Curve V is the bias force at +80° C.

Thus, if the tag is initially tethered at room temperature, e.g. +20° C., the tether 14 holds the cantilever 3 at the tethered zero position X_{T} against a magnetic force M₁ that is almost zero and against a bias force of B₁ that would otherwise move the cantilever 3 to an open position.

If the tag is then cooled to −20° C., the magnetic force increases to M₂, which is above the bias force B₂ at this temperature, and so, when the tether 14 is removed, the free end of the cantilever 3 snaps to the closed position X_{C} in which the poles/contacts 12,13 touch, and where the magnetic force M₃ is even higher than the bias force B₃.

If the tag subsequently experiences a temperature rise to e.g. +20° C., then the magnetic force will reduce to M₄ and the bias force will reduce to B₄. The bias force B₄ will now be greater than the magnetic force M₄, and the cantilever 3 will move towards its open position to an intermediate position X_{I}. If the temperature is again reduced to −20° C., the bias force B₅ is again above the magnetic force M₅, and so the cantilever 3 moves to the fully open position X_{O}, where the two forces M₆, B₆ balance. Further changes in temperature will not affect the cantilever position.

Overall, the cantilever 3 has remembered that the temperature at one point rose above the threshold temperature of −20° C. Therefore, the tag can register this situation, and so for example the refreezing of a product or the like can be detected.

As well as a single cantilever arrangement, the tag 2 could include a number of such cantilevers. FIG. 13 shows a tag 2 having an array 26 of cantilevers 27 provided within a single indicator coil 28 (although a separate coil could alternatively be used for each cantilever or group of cantilevers).

Similar fabricating techniques can be used for the manufacture of this tag as used in the above embodiments. If the tethers 14 are to be electrically fused, then a corresponding electrical array for supplying the fusing currents would also be required. If all of the cantilevers are to be activated simultaneously, then the array need not be addressable, and may take a simple form, as would be well-understood in the art.

In this embodiment, each cantilever 27 may be designed to trip under a different temperature condition. For example, a magnetic restraining circuit of each cantilever 27 may be designed to have a different Curie temperature (e.g. by suitable changes to the copper content of the Thermalloy material), so that the tag 2 can record the passing of a number of threshold temperature levels.

Such an array would then give the actual temperature attained by the tag 2 to an accuracy determined by the differences between the triggering temperatures of the cantilevers. Thus, if, as shown in FIG. 13, the cantilevers #1 to #6 are designed to trip at −20, −16, −12, −8, −4 and 0° C., then if the temperature were to rise to −8° C., all of the sensors up to sensor #5 would trip; On interrogating the tag 2, the user would thus know that the temperature had risen at some point to between −8 and −4° C.

In order to determine which of the cantilevers 27 have tripped, the strength of an impedance change in the coil 28 could be determined, and this could be correlated to the number of cantilevers vibrating. Alternatively, each cantilever 27 could be designed to vibrate at a different resonant frequency, so that a swept RF excitation signal S as shown in FIG. 14 would produce the impedance spikes #1 to #4 in the detected coil impedance.

In other array arrangements, all or some of the cantilevers 27 could have the same Curie temperature, so as to provide redundancy and guard against failure of a cantilever. Such an arrangement could also increase signal strength for easing detection, or, if using cantilevers of different resonance, could provide the tag with a particularly characteristic trip signal made up of harmonics of the different resonances.

Tags according to the present invention, whether of the single cantilever or array types, could be used in association with identification tags, e.g. bar codes, magnetic and optical markings and the like, so that for example an item's identity and temperature history may be recorded simultaneously.

RFID tags would be particularly appropriate for use with the temperature sensor, as both can provide remote interrogation. The RFID tag could take any suitable form, and is preferably an RFID tag as disclosed in co-pending International Patent Application entitled “Memory Devices”, filed on the same day as the present application by the same applicants and claiming priority from Australian Provisional Patent Application No. 2003901240, the contents of which document are disclosed herewith by reference. Memory devices in accordance with this application hold data using an array of tethered resonant members, such as cantilevers, of different resonant frequencies, the data being stored by removing the tethers from selected ones of the cantilevers and being read by applying an excitation signal and analysing the response to determine which resonant members are vibrating.

The RFID and temperature sensing elements could be incorporated into the same tag structure in the same manufacturing process. The temperature sensing cantilevers should be set at frequencies that do not affect reading of the memory cantilevers, and vice versa.

Preferably the devices are passive, but active implementations would also be possible, and instead of only remote interrogation, the tag may have an inbuilt ability to determine the state of the cantilevers and to provide an indication of this. For example, the tags could include power sources and onboard processors for determining the state of the cantilevers. In this case, the tags could themselves provide an indication that they have been triggered, e.g. an LED indicator or the like.

Other alternative implementations of the present invention are also possible. For example, any suitable interrogation system might be used, including other forms of electromagnetic excitation.

Further, the cantilever, or any other suitable vibrating structure, could be vibrated through the use of a Lorentz, electrostatic or piezoelectric force, e.g. as discussed in the above-mentioned co-pending International application entitled “Memory Devices”.

Two such possibilities are shown in FIGS. 15 and 16, in which cantilevered members 3 are shown that could e.g. be used with the temperature sensitive element 11 and the like of FIG. 4.

In FIG. 15, an array of electrostatic cantilevers 3 is shown. These have the tether 14 and the magnetic pole face/contact 12 at their free end for interacting with the pole 13 and temperature-sensitive element 11 of FIG. 4 in the above-discussed manner. The cantilevers 3 also have an electrode 30 along their lengths that connects with an electrical bus 31 at their fixed end. A further electrode 32 is provided above each of the cantilevers 3, for example in the recess of another silicon substrate 33, and each of these electrodes 32 connects with a further electrical bus 34. The electrical buses 31 and 34 connect with a circuit, e.g. including a coil, that can have an ac current induced therein by an externally applied interrogation signal. Thus, in this embodiment, in order to determine if the cantilever 3 is in its triggered vibrational state (i.e. when the tether 14 is removed and when the curie temperature of the restraining element (not shown) has been exceeded), an ac current is induced in the electrical lines 31 and 34, and the impedance of the circuit is monitored. If the impedance shows a change at an ac current frequency corresponding to the resonant frequency of one of the cantilevers 3, then it can be determined that that cantilever has been triggered.

FIG. 16 shows an embodiment that works similarly to the embodiment of FIG. 15, except that the induced ac current in the electrical lines 31, 34 is used to activate a piezoelectric element 35 in each of the cantilevers 3. The piezoelectric element 35 comprises a layer of piezoelectric material between a pair of electrodes that are connected to the lines 31,34, and will strain in accordance with the current across the electrodes so as to deflect the cantilever 3. Again, the impedance of the ac current circuit will change when one or more of the cantilevers resonates.

Other methods of vibration would also be possible, including e.g. the use of magnetostrictive or electrostrictive materials.

The temperature sensing structure need not be limited to use in tags, and may be used in any system where temperature detection may be required. For example, the cantilever structure could be used in one-time use, safety devices and the like, so that the opening of the cantilever contacts could be sensed by a suitable microprocessor circuit or the like and provoke a suitable response.

The tags could also be used for electronic article surveillance, in which case the tags would be made with a high Curie temperature (above room temperature), and could be disabled by applying a suitably high temperature, e.g. from a laser.

Instead of being placed in restrained and vibrating states, the cantilever structure could be placed between states-that vibrate at different frequencies. For example, in one state the cantilever and Thermalloy element may vibrate together, whilst after exceeding the Curie temperature, they may vibrate apart.

The tether in the described embodiment is a fusible Permalloy link. The tether could however take other forms. It could for example comprise an SiO₂ or photo resist tether that is removed by laser ablation to break it.

Instead of a magnetic restraining force, the restraining force could be provided by alternative temperature sensitive elements. For example, especially for higher temperatures, e.g. above room temperatures, meltable materials could be used, e.g. wax, Woods metals or tin eutectics.

Instead of using a cantilever, other vibratable elements could be used, e.g. a bridge portion tethered at either end above a well so that it is able to resonate.

In relation to the vibrating members, it will be understood that as well as resonating at the fundamental resonant frequency, the members may be made to resonate in response to a harmonic frequency of the fundamental frequency.

The described devices could also be modified so to have no bias or to have a bias that does not prevent a cantilever's recapture by the temperature-sensitive element. Such devices would then not have a memory, but could provide the temperature condition experienced by the device at the time of interrogation. For example, a single cantilever would be able to indicate whether or not the temperature was above a threshold value, whilst an array of cantilevers could indicate the current temperature of a tagged object (at the resolution of the individual cantilever temperature settings). Such devices could therefore provide simple and inexpensive thermometers that may be remotely queried. In such cases, the device could itself include interrogation means, such as a microprocessor, and could also include a temperature indicator, e.g. an LED indicator or LCD display. These devices would not need the activation tethers of the above-discussed temperature recording devices.

It is to be understood that various alterations, additions and/or modifications may be made to the parts previously described without departing from the ambit of the present invention, and that, in the light of the teachings of the present invention, the device may be implemented in a variety of manners as would be understood by the skilled person.

1. A temperature condition recording device for recording whether a predetermined temperature condition has been experienced, the device including a cantilever or bridge movable member that assumes a triggered state on exposure of the device to the temperature condition so as to register the occurrence of the temperature condition, wherein the device is configured to be interrogated by an r.f. excitation signal, and wherein when said movable member is triggered, the device provides a characteristic response to the excitation signal.

2. (canceled)

3. The device of claim 1, wherein the device includes indicator circuitry associated with the movable member, the circuitry providing a characteristic response to the signal when the movable member is in a triggered state.

4. The device of claim 3, wherein the circuitry includes a coil with which the excitation signal couples.

5. The device of claim 1, wherein the movable member is able to vibrate when in the triggered state.

6. The device of claim 1, wherein the movable member acts as a switch in an associated circuit.

7. The device of claim 1, wherein the device includes a temperature-sensitive element that prevents movement of said movable member to said triggered state unless said predetermined temperature condition is experienced.

8. The device of claim 1, wherein the device includes a temperature-sensitive magnetic element that determines the state of said movable member.

9. The device of claim 8, wherein said magnetic element releases said movable member, when said temperature condition occurs.

10. The device of claim 1, wherein said movable member is biased to said triggered state, and wherein a temperature-sensitive element holds said movable member against said bias until occurrence of the predetermined temperature condition.

11. The device of claim 7, wherein said temperature-sensitive element includes a magnetic element having a Curie temperature corresponding to the temperature condition.

12. The device of claim 1, wherein the movable member is held against movement by a magnetic element, and wherein the magnetic element has a Curie temperature corresponding to a desired temperature threshold such that on passing the threshold, the magnetic force acting on the movable member is reduced so as to allow the member to move.

13. The device of claim 1, wherein the device records whether a threshold temperature has been passed, wherein the movable member is formed at least in part from a soft magnetic material and is coupled to a permanent magnet, wherein the movable member is held against a bias out of the triggered position by attraction to a temperature-sensitive magnetic material that is coupled to a permanent magnet and that has a Curie temperature corresponding to the threshold temperature, and wherein when said threshold temperature is exceeded, the magnetic attraction is reduced and the movable member moves to the triggered position.

14. The device of claim 1, wherein said temperature condition is the exceeding of a temperature threshold.

15. The device of claim 14, wherein said temperature condition is an increase in temperature above a threshold temperature.

16. The device of claim 1, wherein the device is held prior to use in an inactive state by an activation element that retains the movable member in an untriggered state independent of the predetermined temperature condition, and wherein the activation element is able to be disabled so as to activate the device.

17. The device of claim 1, wherein, in an inactive state, an activation element holds the movable member against a bias in a non-triggered state in a position in which, on activation of the device, a temperature-sensitive element is able to hold said movable element out of the triggered state until said temperature condition is experienced.

18. The device of claim 1, wherein the device includes a removable tether as an activation element that holds the movable member in a non-triggered state.

19. The device of claim 16, wherein the device includes circuitry for passing a current through the activation element so as to fuse it.

20. The device of claim 16, wherein the activation element is configured to be removable through ablation.

21. (canceled)

22. The device of claim 1, wherein the movable member is configured to vibrate at a set resonant frequency.

23. The device according to claim 1, wherein the device includes a plurality of movable members, each being triggered by a different temperature condition.

24. The device of claim 1, wherein the device includes a plurality of movable members, each being restrained by a temperature-sensitive magnetic element, the temperature-sensitive magnetic elements having different Curie temperatures from one another.

25. The device of claim 1, wherein the device includes a plurality of movable members, each being configured to vibrate at a different resonant frequency.

26. The device of claim 1, wherein the movable member is fabricated by MEMS technology.

27. (canceled)

28. (canceled)

29. The device of claim 1, wherein the device is configured such that once the movable member has been triggered, the movable member cannot return to its non-triggered state.

30. A temperature condition monitoring system for determining whether an item has experienced a set temperature condition, the system including a device in accordance with any preceding claim, and an interrogator including a signal generator for applying an interrogation signal to the device and a receiver for receiving a response to the interrogation signal and for analysing the signal in order to determine if the device has been triggered.

31.-34. (canceled)

35. A method of determining whether an item has been exposed to a particular temperature condition, including the step of applying a temperature sensing device to the item, the temperature sensing device including a movable member that when exposed to the temperature condition moves to a triggered position in which it causes the device to respond to an excitation signal with a characteristic response signal, and the step of applying an excitation signal to the device to determine if the characteristic response is received.

36. The method of claim 25, wherein movable member is biased towards a triggered position, but is held by an activation element in a non-triggered state in a position in which on activation of the device a temperature-sensitive element is able to prevent the movable member from triggering when said temperature condition has not occurred;
the method further including the steps of:
placing the item in a condition other than the set temperature condition;
disabling the activation element; and
at a later time detecting whether said movable member has triggered.

37. A method of fabricating a temperature monitoring device including the steps of depositing a permanent magnet onto a dielectric substrate, depositing and etching a cantilever or bridge structure onto the dielectric substrate such that the structure is coupled to the permanent magnet and is biased to a first triggered state, and depositing a temperature-sensitive magnetic structure onto the substrate so that it is coupled to the permanent magnet, the arrangement being such that when the temperature-sensitive magnetic structure is below its Curie temperature it is able to restrain said cantilever or bridge structure against said bias in an untriggered state, and when said Curie temperature is exceeded, said cantilever or bridge structure is able to move to said triggered state under said bias.

38. The method of claim 37, wherein the cantilever or bridge structure is fabricated with an integral tether that holds the structure in an untriggered state prior to activation of the device by removal of the tether.

39.-49. (canceled)

50. A temperature-sensing device having a movable element that moves to a triggered position on experiencing a set temperature condition, movement of the movable element to the triggered position altering the response of an associated circuit to an interrogation signal.

51. A temperature sensor including a vibratable element that is held against vibration when the device has not experienced a predetermined temperature condition, but that is released to vibrate once the temperature condition has been experienced.

52. The sensor of claim 5 1, wherein the sensor includes a circuit whose response to an interrogation signal alters depending on whether said vibratable element is able to vibrate.

53. The sensor of claim 51, wherein the sensor includes an activation element that prevents the vibratable element from vibrating irrespective of the temperature conditions, and that is disabled in order to activate the sensor.

54. The method of claim 25, wherein the movable member a vibratable member that is restrained against vibration unless it has been exposed to the temperature condition, and the step of applying an excitation signal to said device includes analysing the response to determine whether the vibratable element is vibrating.

55. (canceled)

56. A temperature registering tag for determining when an item associated with the tag has been exposed to temperatures that exceed a threshold value, the tag including a trigger element that is held in a first state against a bias by a temperature-sensitive magnetic element, the magnetic element having a Curie Temperature corresponding to the threshold temperature, the trigger element being placed in a triggered state when the temperature exceeds the threshold temperature due to a reduction in the magnetic force exerted by the temperature-sensitive element.

57. A tag having a temperature-sensitive restraining means that prevents a trigger element from being triggered unless the tag has experienced a set temperature condition, and a temperature-independent restraining means that prevents triggering, wherein the temperature-independent restraining means can be disabled so as to activate the tag.

58. (canceled)

59. A temperature monitoring device including a first movable member that can assume a triggered state on experiencing a set temperature condition and a plurality of resonant members of different resonant frequencies from one another and from the first movable member that vibrate in response to an interrogation signal in order to provide identification data.

60. A temperature-sensing tag for an item including a movable member that is held in a first state by a temperature-sensitive element, and that is released into a second state when the item experiences a predetermined temperature condition.

61.-64. (canceled)
